(19) United States
(12) Patent Application Publication
(10) Pub. No.: US 2017/0148367 A1
(43) Pub. Date: May 25, 2017

(54) DISPLAY APPARATUS AND A METHOD OF DRIVING DISPLAY PANEL USING THE SAME

(71) Applicant: SAMSUNG DISPLAY CO., LTD., YONGIN-SI (KR)

(72) Inventors: KYUNG-HO PARK, SUWON-SI (KR); SU-JI PARK, SEOUL (KR); BAEK-KYUN JEON, YONGIN-SI (KR)

(21) Appl. No.: 15/154,312

(22) Filed: May 13, 2016

(30) Foreign Application Priority Data
Nov. 19, 2015 (KR) 10-2015-0162689

(51) Int. Cl. G09G 3/20

(52) U.S. Cl. CPC G09G 3/2003; G09G 3/2018; G09G 3/2074; G09G 2310/08; G09G 2300/0439

(57) ABSTRACT

A display apparatus includes a display panel, a timing controller and a data driver. The display panel includes a plurality of sub-pixels to display an image. The timing controller generates a data signal and compensation data based on an optimum common voltage of odd-numbered line sub-pixels and an optimum common voltage of even-numbered line sub-pixels. The data driver converts the data signal into a data voltage and to output the data voltage to the display panel.

### CROSS-REFERENCE TO RELATED APPLICATIONS

This application claims priority under 35 U.S.C. §119 to Korean Patent Application No. 10-2015-0162689, filed on Nov. 19, 2015 in the Korean Intellectual Property Office KIPO, the contents of which are herein incorporated by reference in their entireties.

### TECHNICAL FIELD

Exemplary embodiments of the present inventive concept relates to a display apparatus and method of driving a display panel using the display apparatus.

### DISCUSSION OF RELATED ART

A display apparatus generally includes a display panel and a display panel driver. The display panel includes a plurality of gate lines, a plurality of data lines and a plurality of sub-pixels. The sub-pixels are connected to the plurality of gate lines and the plurality of data lines. The display panel driver includes a timing controller, a gate driver and a data driver. The gate driver outputs a gate signal to the gate line. The data driver outputs a data voltage to the data line. The sub-pixels of the display panel produce a degree of luminance based on the data voltage.

When a display panel is driven at a low frequency (30 hz), a difference in sub-pixel luminance may be made more apparent and an image being displayed may appear to flicker.

### SUMMARY

According to an exemplary embodiment of the inventive concept, a display apparatus includes a display panel, a timing controller and a data driver. The display panel displays an image and comprises a plurality of odd-numbered line sub-pixels and a plurality of even-numbered line sub-pixels. The timing controller generates a data signal and compensation data based on an optimum common voltage of the odd-numbered line sub-pixels and an optimum common voltage of the even-numbered line sub-pixels. The data driver converts the data signal into a data voltage and outputs the data voltage to the display panel.

In an exemplary embodiment of the inventive concept, the data signal may be adjusted by the compensation data corresponding to the optimum common voltage of the even-numbered line sub-pixels to the voltage level of a data voltage corresponding to the optimum common voltage of the odd-numbered line sub-pixels.

In an exemplary embodiment of the inventive concept, the compensation data may be obtained by subtracting the optimum common voltage of the even-numbered line sub-pixels from the optimum common voltage of the odd-numbered line sub-pixels.

In an exemplary embodiment of the inventive concept, the data driver may output a data voltage corresponding to the even-numbered line sub-pixels by adding the optimum common voltage of even-numbered line sub-pixels to the compensation data.

In an exemplary embodiment of the inventive concept, the data signal may be adjusted by the compensation data corresponding to the optimum common voltage of the odd-numbered line sub-pixels to the voltage level of a data voltage corresponding to the optimum common voltage of the even-numbered line sub-pixels.

In an exemplary embodiment of the inventive concept, the compensation data may be obtained by subtracting the optimum common voltage of the odd-numbered line sub-pixels from the optimum common voltage of the even-numbered line sub-pixels.

In an exemplary embodiment of the inventive concept, the data driver may output a data voltage corresponding to the odd-numbered line sub-pixels by adding the optimum common voltage of the odd-numbered line sub-pixels to the compensation data.

In an exemplary embodiment of the inventive concept, the timing controller may generate a gate control signal controlling a gate on-time of the odd-numbered line sub-pixels and a gate on-time of the even-numbered line sub-pixels.

In an exemplary embodiment, the display apparatus may include a gate driver to output a gate signal driving the odd-numbered line sub-pixels and a gate on-time of the even-numbered line sub-pixels based on the gate control signal. The gate driver may output the gate signal to the even-numbered line sub-pixels and after a predetermined time the gate driver outputs the gate signal to the odd-numbered line sub-pixels.

In an exemplary embodiment of the inventive concept, the display panel may include a switching element, an organic layer, a pixel electrode and a common electrode. The switching element may be disposed on a substrate and include a gate electrode, a source electrode and a drain electrode. The organic layer may be disposed on the switching element. The pixel electrode may be disposed on the organic layer and may be electrically connected to the drain electrode. The common electrode may overlap the pixel electrode. The source electrode and the drain electrode may overlap the gate electrode.

According to an exemplary embodiment of the inventive concept, the method includes calculating an optimum common voltage of odd-numbered line sub-pixels and an optimum common voltage of even-numbered line sub-pixels, generating a data signal and compensation data based on the calculated optimum common voltage of the odd-numbered line sub-pixels and the optimum common voltage of the even-numbered line sub-pixels and converting the generated data signal into a data voltage of the odd-numbered line sub-pixels and a data voltage of the even-numbered line sub-pixels and outputting the data voltage to the display panel.

In an exemplary embodiment of the inventive concept, the data signal is adjusted by the compensation data corresponding to the optimum common voltage of the even-numbered line sub-pixels to the voltage level of a data voltage corresponding to the optimum common voltage of the odd-numbered line sub-pixels.

In an exemplary embodiment of the inventive concept, the compensation data may be obtained by subtracting the optimum common voltage of the even-numbered line sub-pixels from the optimum common voltage of the odd-numbered line sub-pixels.

In an exemplary embodiment of the inventive concept, the data driver may output a data voltage of the even-numbered line sub-pixels by adding the optimum common voltage of the even-numbered line sub-pixels to the compensation data.

In an exemplary embodiment of the inventive concept, the data signal is adjusted by the compensation data corresponding to the optimum common voltage of the odd-numbered line sub-pixels to the voltage level of a data voltage corresponding to the optimum common voltage of the even-numbered line sub-pixels.

In an exemplary embodiment of the inventive concept, the compensation data may be obtained by subtracting the optimum common voltage of the odd-numbered line sub-pixels from the optimum common voltage of the even-numbered line sub-pixels.

In an exemplary embodiment of the inventive concept, the data driver may output a data voltage of the odd-numbered line sub-pixels by adding the optimum common voltage of the odd-numbered line sub-pixels to the compensation data.

In an exemplary embodiment of the inventive concept, the method may include generating a gate control signal controlling a gate on-time of the odd-numbered line sub-pixels and a gate on-time of the even-numbered line sub-pixels.

In an exemplary embodiment, the method include outputting a gate signal driving the odd-numbered line sub-pixels and outputting a gate on-time of the even-numbered line sub-pixels based on the gate control signal. Outputting the gate signal may include outputting the gate signal to the even-numbered line sub-pixels and outputting the gate signal to the odd-numbered line sub-pixels at a predetermined time after the gate signal to the even-numbered line sub-pixels is output.

In an exemplary embodiment, the display panel may include a switching element, an organic layer, a pixel electrode and a common electrode. The switching element may be disposed on a substrate and comprising a gate electrode, a source electrode and a drain electrode. The organic layer may be disposed on the switching element. The pixel electrode may be disposed on the organic layer and may be electrically connected to the drain electrode. The common electrode may overlap the pixel electrode. The source electrode and the drain electrode may overlap the gate electrode.

According to an exemplary embodiment of the inventive concept, a display apparatus may include a plurality of odd-numbered line sub-pixels, a plurality of even-numbered line sub-pixels, a timing controller and a data driver. The plurality of odd-numbered line sub-pixels has a first optimum common voltage. The plurality of even-numbered line sub-pixels has a second optimum common voltage. The timing controller generates a data signal. The data driver generates a data voltage from the data signal and the first optimum common voltage or the second optimum common voltage and to output the data voltage to the plurality of odd-numbered line sub-pixels and the plurality of even-numbered line sub-pixels.

In an exemplary embodiment of the inventive concept, the timing controller may generate a compensation data from a difference between the first optimum common voltage and the second optimum common voltage.

In an exemplary embodiment of the inventive concept, the data driver may apply the compensation data to the first optimum common voltage or the second optimum common voltage prior to generating the data voltage.

In an exemplary embodiment of the inventive concept, the data driver may subtract the compensation data from the second optimum common voltage when the second optimum common voltage is higher than the first optimum common voltage.

In an exemplary embodiment of the inventive concept, the data driver may subtract the compensation data from the optimum common voltage when the first optimum common voltage is higher than the second optimum common voltage.

### BRIEF DESCRIPTION OF THE DRAWINGS

Exemplary embodiments of the inventive concept will be more clearly understood from the following detailed description taken in conjunction with the accompanying drawings, in which:

FIG. 1 is a block diagram illustrating a display apparatus according to an exemplary embodiment of the inventive concept;

FIG. 2 is a plan view illustrating a display panel of a display apparatus according to an exemplary embodiment of the inventive concept;

FIG. 3 is a cross-sectional view taken along a line I-I′ of FIG. 2;

FIG. 4 is a graph illustrating a gate voltage of a method of driving a display panel according to an exemplary embodiment of the inventive concept;

FIG. 5 is a graph illustrating a data voltage for driving a display panel according to an exemplary embodiment of the inventive concept;

FIG. 6 is a block diagram illustrating a method of driving a display panel according to an exemplary embodiment of the inventive concept;

FIG. 7 is a block diagram illustrating generating a compensation data according to an exemplary embodiment of the inventive concept; and

FIG. 8 is a block diagram illustrating a method of driving a display panel according to an exemplary embodiment of the inventive concept.

### DETAILED DESCRIPTION OF THE INVENTIVE CONCEPT

Hereinafter, various exemplary embodiments of the present inventive concept will be explained in detail with reference to the accompanying drawings.

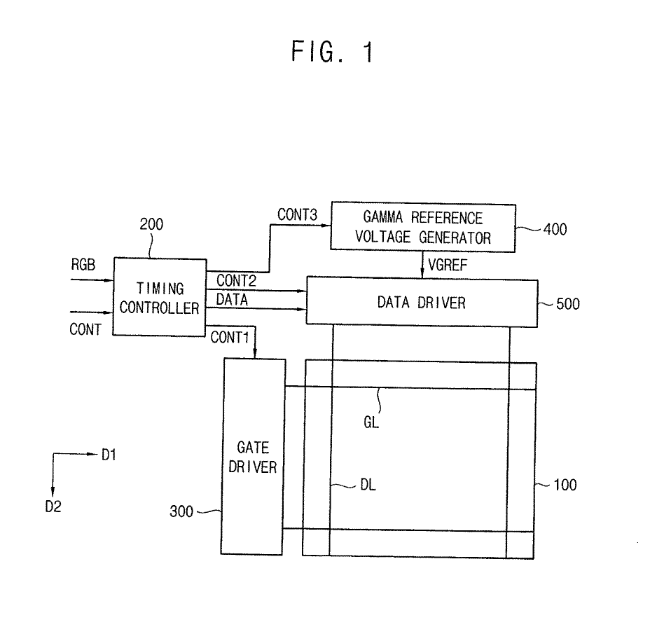

FIG. 1 is a block diagram illustrating a display apparatus according to an exemplary embodiment of the inventive concept.

Referring to FIG. 1, the display apparatus includes a display panel 100 and a display panel driver. The display panel driver includes a timing controller 200, a gate driver 300, a gamma reference voltage generator 400 and a data driver 500.

The display panel 100 displays an image based on input image data. The display panel 100 has a display region on which the image is displayed and a peripheral region adjacent to the display region.

The display panel 100 includes a plurality of gate lines GL, a plurality of data lines DL and a plurality of sub-pixels connected to the gate lines GL and the data lines DL. The gate lines GL extend in a first direction D1 and the data lines DL extend in a second direction D2 crossing the first direction D1.

Each sub-pixel includes a switching element SW and a capacitor electrically connected to the switching element SW. The sub-pixels may be disposed in a matrix form. For example, the switching element SW may be a thin film transistor.

For example, the display apparatus may be a liquid crystal display apparatus. For example, the display apparatus may be an organic light emitting diode display apparatus. The present inventive concept may be applied to various display apparatuses which include the thin film transistor.

The timing controller 200 receives the input image data RGB and an input control signal CONT from an external apparatus. The input image data may include red image data R, green image data G and blue image data B. The input control signal CONT may include a master clock signal and a data enable signal. The input control signal CONT may include a vertical synchronizing signal and a horizontal synchronizing signal.

The timing controller 200 generates a first control signal CONT1, a second control signal CONT2, a third control signal CONT3 and a data signal DATA based on the input image data RGB and the input control signal CONT.

The timing controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates a data signal compensating for a difference between an optimum common voltage of odd-numbered line sub-pixels and an optimum common voltage of even-numbered line sub-pixels.

The timing controller 200 generates a compensation data compensating for a difference between an optimum common voltage of odd-numbered line sub-pixels and an optimum common voltage of even-numbered line sub-pixels. The compensation data is defined as a value obtained by subtracting the optimum common voltage of even-numbered line sub-pixels from the optimum common voltage of odd-numbered line sub-pixels.

The timing controller 200 generates the third control signal CONT3 for controlling an operation of the gamma reference voltage generator 400 based on the input control signal CONT. The timing controller 200 outputs the third control signal CONT3 to the gamma reference voltage generator 400.

The gate driver 300 generates gate signals for driving the gate lines GL in response to the first control signal CONT1 received from the timing controller 200. The gate driver 300 sequentially outputs the gate signals to the gate lines GL. The gate driver 300 outputs a gate signal driving the odd-numbered line sub-pixels and a gate on-time of the even-numbered line sub-pixels based on the gate control signal. The gate driver outputs the gate signal to the even-numbered line sub-pixels and, after a predetermined time the gate driver outputs the gate signal to the odd-numbered line sub-pixels.

In an exemplary embodiment of the inventive concept, gate driver 300 may be integrated on the peripheral portion of the display panel 100. In an exemplary embodiment, the gate driver 300 may be directly mounted on the display panel 100, or may be connected to the display panel 100 as a tape carrier package (TCP) type.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA.

In an exemplary embodiment, the gamma reference voltage generator 400 may be disposed in the timing controller 200, or in the data driver 500.

The data driver 500 receives the second control signal CONT2 and the data signal DATA from the timing controller 200, and receives the gamma reference voltages VGREF from the gamma reference voltage generator 400. The data driver 500 converts the data signal DATA into analog data voltages using the gamma reference voltages VGREF. The data driver 500 outputs the data voltages to the data lines DL.

The data driver 500 adjusts the data voltage of the odd-numbered line sub-pixels or the even-numbered line sub-pixels based on the data signal compensating difference and outputs the adjusted data voltage. For example, when the data driver determines that the optimum common voltage of the even-numbered line sub-pixels is higher than the optimum common voltage of the odd-numbered line sub-pixels the data driver may adjust the data voltage of the even-numbered line sub-pixels based on the compensation voltage. In an example, when the data driver determines that the optimum common voltage of the odd-numbered line sub-pixels is higher than the optimum common voltage of the even-numbered line sub-pixels the data driver may adjust the data voltage of the odd-numbered line sub-pixels based on the compensation voltage. The compensation data is the difference between an optimum common voltage of the odd-numbered line sub-pixels and an optimum common voltage of the even-numbered line sub-pixels.

When a data voltage of the odd-numbered line sub-pixels is compensated based on the data voltage of the even-numbered line sub-pixels, the data driver 500 may add the optimum common voltage of odd-numbered line sub-pixels to the compensation data to output a data voltage of odd-numbered line sub-pixels.

In addition, when a data voltage of the even-numbered line sub-pixels is compensated based on the data voltage of the odd-numbered line sub-pixels, the data driver 500 may add the optimum common voltage of even-numbered line sub-pixels to the compensation data to output a data voltage of even-numbered line sub-pixels.

In an exemplary embodiment of the inventive concept, data driver 500 may be directly mounted on the display panel 100, or be connected to the display panel 100 in a TCP type. In an exemplary embodiment, the data driver 500 may be integrated on the display panel 100.

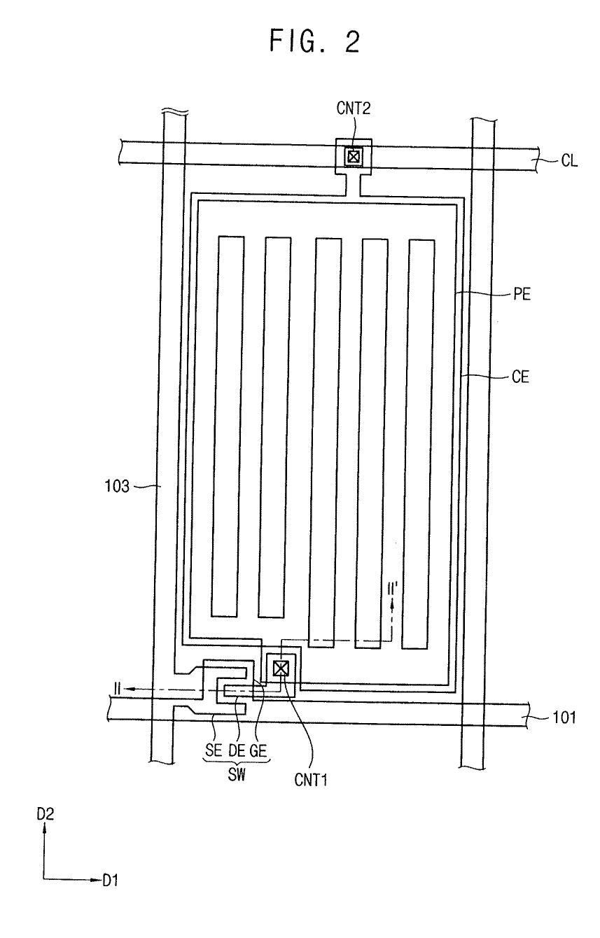

FIG. 2 is a plan view illustrating a display panel of a display apparatus according to an exemplary embodiment of the inventive concept. FIG. 3 is a cross-sectional view taken along a line II-II′ of FIG. 2.

Referring to FIGS. 2 and 3, according to an exemplary embodiment of the present inventive concept a display panel of a display apparatus includes a base substrate 110, a gate metal pattern disposed on the base substrate 110, a data metal pattern disposed on the gate metal pattern, a pixel electrode PE and a common electrode CE.

The gate metal pattern includes a gate line 101 extending in a first direction D1 and a gate electrode GE electrically connected to the gate line 101.

The data metal pattern includes a data line 103 extending in a second direction D2 crossing the first direction D1, a source electrode SE electrically connected to the data line 103 and a drain electrode DE spaced apart from the source electrode SE. The switching element SW may include the source electrode SE, the drain electrode DE and the gate electrode GE.

Examples of the base substrate 110 may include a glass substrate, a quartz substrate, a silicon substrate, a plastic substrate or the like.

The gate electrode GE is disposed on the base substrate 110. The gate electrode GE may have a single layer structure including copper (Cu), silver (Ag), chromium (Cr), molybdenum (Mo), aluminum (Al), titanium (Ti), manganese (Mn) or an alloy thereof. In addition, the gate electrode GE may have a multi layer structure having a plurality of layers including materials different each other. For example, the gate electrode GE may include a copper layer and a titanium layer disposed on and/or under the copper layer.

The gate insulation layer 112 is formed on the gate electrode GE. The gate insulation layer 112 may cover the base substrate 110 and the gate electrode GE. The gate insulation layer 112 may include inorganic material such as silicon oxide (SiOx) and/or silicon nitride (SiNx). For example, the gate insulation layer 112 includes silicon oxide (SiOx), and may have thickness about 500 Å. In addition, the gate insulation layer 112 may include a plurality of layers including materials different each other.

An active pattern AP is formed on the gate insulation layer 112. The active pattern AP is formed on the gate insulation layer 112 adjacent to the gate electrode GE. The active pattern AP may overlap the gate electrode GE. The active pattern AP may be partially overlapped by the source electrode SE and the drain electrode DE. The active pattern AP may be disposed between the gate electrode GE and the source electrode SE. The active pattern AP may be disposed between the gate electrode GE and the drain electrode DE.

The source electrode SE and the drain electrode DE may be formed on the active pattern AP. The source electrode SE and the drain electrode DE may be spaced apart from each other.

The source electrode SE and the drain electrode DE may have a single layer structure including copper (Cu), silver (Ag), chrome (Cr), molybdenum (Mo), aluminum (Al), titanium (Ti), manganese (Mn) or a mixture thereof. In addition, the source electrode SE and the drain electrode DE may have a multi layer structure. Each layer of the multi layer structure may include materials different from each other. For example, the source electrode SE and the drain electrode DE may include a copper layer and a titanium layer disposed on and/or under the copper layer.

The first passivation layer 113 may be formed on the source electrode SE and the drain electrode DE. The first passivation layer 113 may be formed with a material including silicon oxide (SiOx) or silicon nitride (SiNx).

The organic layer 114 is formed on the first passivation layer 113. The organic layer 114 planarizes an upper surface of the display panel.

The pixel electrode PE is formed on the organic layer 114. The pixel electrode PE may include a transparent conductive material, such as indium tin oxide (ITO), indium zinc oxide (IZO) and etc. In addition, the pixel electrode PE may include titanium (Ti) and/or molybdenum titanium (MoTi). The pixel electrode PE may be electrically connected with the drain electrode DE. The pixel electrode PE may be electrically connected with the drain electrode DE through the first contact hole CNT1.

The second passivation layer 116 may be formed on the pixel electrode PE. The second passivation layer 116 may be formed with a material including silicon oxide (SiOx) or silicon nitride (SiNx).

The common electrode CE may be formed on the second passivation layer 116. The common electrode CE may overlap the pixel electrode PE. The common electrode CE may include a transparent conductive material, such as indium tin oxide (ITO), indium zinc oxide (IZO) and etc. In addition, the common electrode CE may include titanium (Ti) and/or molybdenum titanium (MoTi). The common electrode CE may be electrically connected with the common line CL. A common voltage may be applied to the common electrode CE from the common line CL. The common electrode CE may be electrically connected with the common line CL through the second contact hole CNT2.

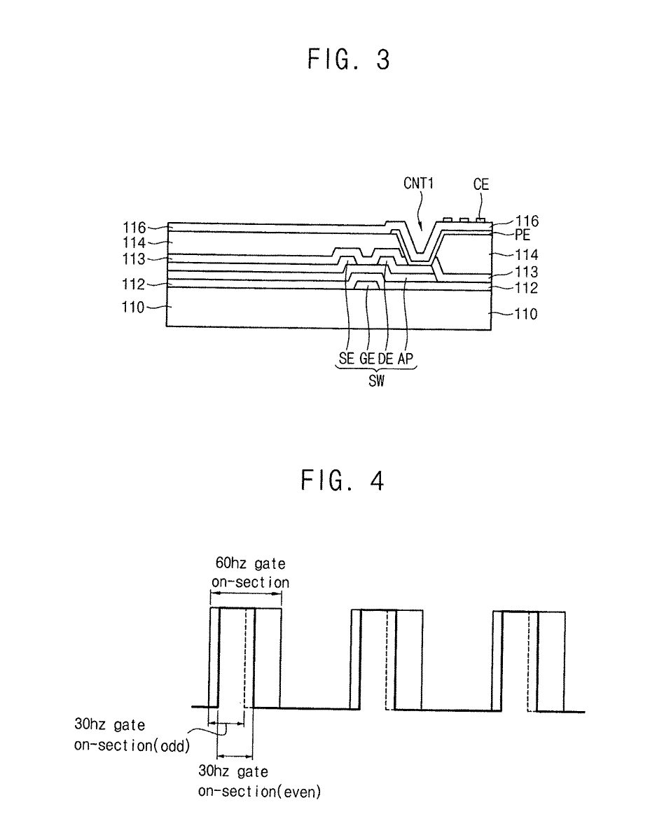

FIG. 4 is a graph illustrating a gate voltage for driving a display panel according to an exemplary embodiment of the inventive concept.

Referring to FIG. 4, the gate driver outputs the gate signal to the even-numbered line sub-pixels and, after a predetermined time the gate driver outputs the gate signal to the odd-numbered line sub-pixels.

When a positive polarity and a negative polarity are driven simultaneously, a difference between a luminance of the positive polarity and a luminance of the negative polarity may occur. However, when a display panel is driven by a low frequency (less than 30 hz), a driving section may be decreased to less than ½ of a driving section when a display panel is driven by 60 hz. Thus, when a display panel is driven by a low frequency (less than 30 hz), a free section in which the display panel is not driven at a low frequency but is driven at a higher frequency may be obtained. In an exemplary embodiment, the gate driver outputs the gate signal to the even-numbered line sub-pixels and after a predetermined time the gate driver outputs the gate signal to the odd-numbered line sub-pixels. Since the gate driver outputs the gate signal to the even-numbered line sub-pixels and after a predetermined time the gate driver outputs the gate signal to the odd-numbered line sub-pixels, a luminance difference may be minimized reducing flicker.

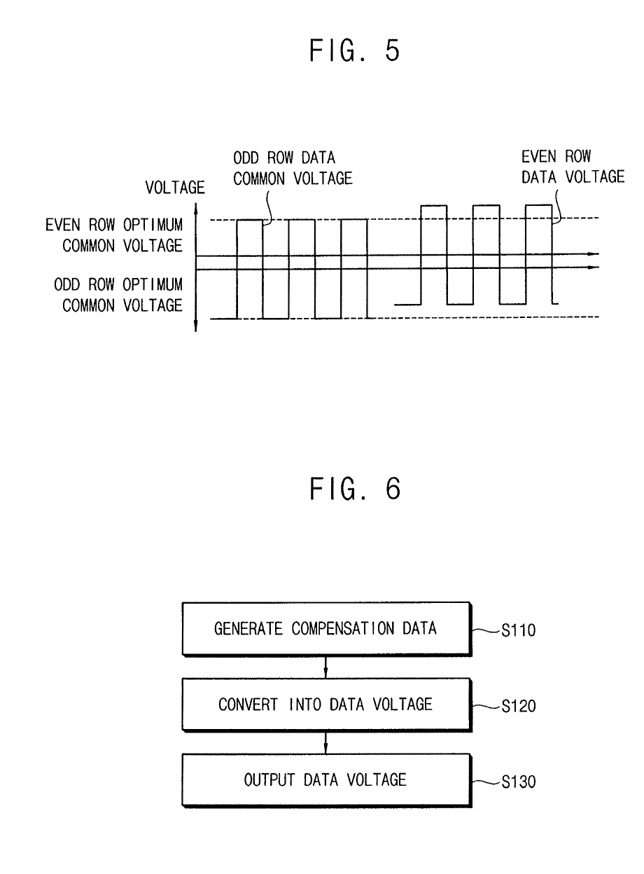

FIG. 5 is a graph illustrating a data voltage of a method of driving a display panel according to an exemplary embodiment of the inventive concept.

Referring to FIG. 5, an optimum common voltage of odd-numbered line sub-pixels and an optimum common voltage of even-numbered line sub-pixels are inconsistent. For example, an optimum common voltage of even-numbered line sub-pixels is higher than an optimum common voltage of odd-numbered line sub-pixels. The difference in optimum common voltage may result in the luminance difference between the odd-numbered line sub-pixels and the even-numbered line sub-pixels.

An optimum common voltage of odd-numbered line sub-pixels and an optimum common voltage of even-numbered line sub-pixels may be determined. A difference between the optimum common voltage of odd-numbered line sub-pixels and the optimum common voltage of even-numbered line sub-pixels may be compensated for.

For example, as illustrated in FIG. 5, since an optimum common voltage of even-numbered line sub-pixels is higher than an optimum common voltage of odd-numbered line sub-pixels, the data driver outputs a value adding a compensation data to the optimum common voltage of even-numbered line sub-pixels to generate a data voltage for the even-numbered line sub-pixels. The compensation data is defined as a value obtained by subtracting the optimum common voltage of even-numbered line sub-pixels from the optimum common voltage of odd-numbered line sub-pixels

Since the data voltage corresponding to the optimum common voltage of the even-numbered line sub-pixels is adjusted to the voltage level of the optimum common voltage of odd-numbered line sub-pixels the luminance difference may be minimized resulting in decreased flickering.

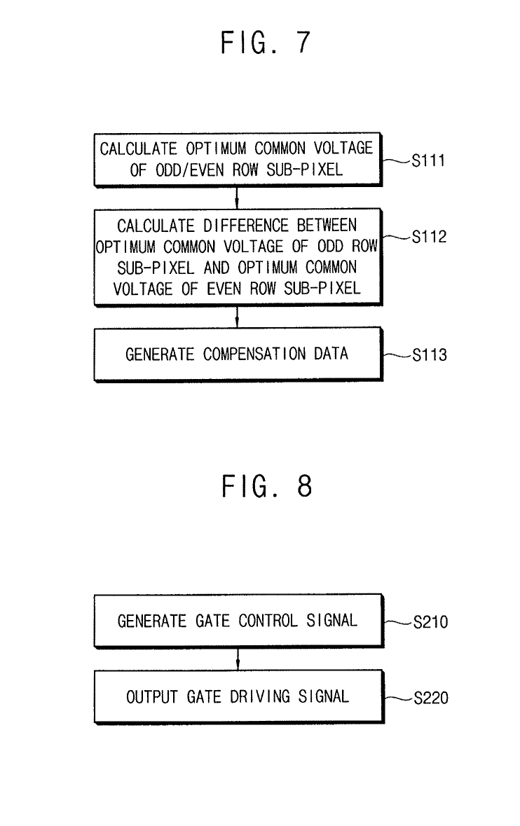

FIG. 6 is a block diagram illustrating a method of driving a display panel according to an exemplary embodiment of the inventive concept. FIG. 7 is a block diagram illustrating generating a compensation data according to an exemplary embodiment of the inventive concept.

Referring to FIGS. 6 and 7, a method of driving a display panel according to an exemplary embodiment of the inventive concept includes generating a compensation data S110, converting a data signal into a data voltage S120 and outputting the data voltage S130.

In the process of generating the compensation data S110, a timing controller generates a compensation data. The compensation data is a difference between an optimum common voltage of odd-numbered line sub-pixels and an optimum common voltage of even-numbered line sub-pixels.

To generate the compensation data, an optimum common voltage of odd-numbered line sub-pixels and an optimum common voltage of even-numbered line sub-pixels are calculated S111. The difference between an optimum common voltage of odd-numbered line sub-pixels and an optimum common voltage of even-numbered line sub-pixels is calculated S112. The compensation data is generated based on the difference between an optimum common voltage of odd-numbered line sub-pixels and an optimum common voltage of even-numbered line sub-pixels S113.

In an exemplary embodiment of the inventive concept, the compensation data is a value obtained by subtracting the optimum common voltage of even-numbered line sub-pixels from the optimum common voltage of odd-numbered line sub-pixels. In an exemplary embodiment, the compensation data is obtained by subtracting the optimum common voltage of odd-numbered line sub-pixels from the optimum common voltage of even-numbered line sub-pixels.

In the process of converting the data signal into the data voltage S120, a data driver converts the data signal into a data voltage based on the compensation data.

The data driver may generate a data voltage of the even-numbered line sub-pixels by compensating the optimum common voltage of the even-numbered line sub-pixels based on the data voltage of the odd-numbered line sub-pixels. The compensation data is obtained by subtracting the optimum common voltage of even-numbered line sub-pixels from the optimum common voltage of odd-numbered line sub-pixels. The data driver generates a data voltage by adding the optimum common voltage of even-numbered line sub-pixels to the compensation data.

The data driver may generate a data voltage of the odd-numbered line sub-pixels by compensating the optimum common voltage of the odd-numbered line sub-pixels based on the data voltage of the even-numbered line sub-pixels. The compensation data is a value obtained by subtracting the optimum common voltage of odd-numbered line sub-pixels from the optimum common voltage of even-numbered line sub-pixels. The data driver generates a data voltage by adding the optimum common voltage of odd-numbered line sub-pixels to the compensation data.

In the process of outputting the data voltage S130, the data driver outputs adjusted data voltage to the odd-numbered line sub-pixels or the even-numbered line sub-pixels.

FIG. 8 is a block diagram illustrating a method of driving a display panel according to an exemplary embodiment of the inventive concept.

Referring to FIG. 8, a method of driving a display panel according to an exemplary embodiment of the inventive concept includes generating a gate control signal 5210 and outputting a gate driving signal S220.

The timing controller generates a gate control signal 5210. The timing controller generates a gate control signal controlling a gate on-time of the odd-numbered line sub-pixels and a gate on-time of the even-numbered line sub-pixels.

The gate driver outputs the gate signal to the even-numbered line sub-pixels and after a predetermined time the gate driver outputs the gate signal to the odd-numbered line sub-pixels.

According to an exemplary embodiment of the inventive concept, a method of driving a display panel includes outputting the data voltage of the odd-numbered line sub-pixels or the even-numbered line sub-pixels based on a data signal compensating difference between an optimum common voltage of odd-numbered line sub-pixels and an optimum common voltage of even-numbered line sub-pixels. In addition, the gate driver outputs the gate signal to the even-numbered line sub-pixels and after a predetermined time the gate driver outputs the gate signal to the odd-numbered line sub-pixels.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings of the present inventive concept. Accordingly, all such modifications are intended to be included within the scope of the present inventive concept as defined in the claims. Therefore, it is to be understood that the foregoing is illustrative of the present inventive concept and is not to be construed as limited to the exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A display apparatus comprising:
a display panel configured to display an image, the display panel comprising a plurality of odd-numbered line sub-pixels and a plurality of even-numbered line sub-pixels;
a timing controller configured to generate a data signal and compensation data based on an optimum common voltage of the odd-numbered line sub-pixels and an optimum common voltage of the even-numbered line sub-pixels; and
a data driver configured to convert the generated data signal into a data voltage and to output the data voltage to the display panel.

2. The display apparatus of claim 1, wherein the data signal is adjusted by the compensation data corresponding to the optimum common voltage of the even-numbered line sub-pixels to the voltage level of a data voltage corresponding to the optimum common voltage of the odd-numbered line sub-pixels.

3. The display apparatus of claim 2, wherein the compensation data is obtained by subtracting the optimum common voltage of the even-numbered line sub-pixels from the optimum common voltage of the odd-numbered line sub-pixels.

4. The display apparatus of claim 3, wherein the data driver outputs a data voltage corresponding to the even-numbered line sub-pixels by adding the optimum common voltage of even-numbered line sub-pixels to the compensation data.

5. The display apparatus of claim 1, wherein the data signal is adjusted by the compensation data corresponding to the optimum common voltage of the odd-numbered line sub-pixels to the voltage level of a data voltage corresponding to the optimum common voltage of the even-numbered line sub-pixels.

6. The display apparatus of claim 5, wherein the compensation data is obtained by subtracting the optimum common voltage of the odd-numbered line sub-pixels from the optimum common voltage of the even-numbered line sub-pixels.

7. The display apparatus of claim 6, wherein the data driver outputs a data voltage corresponding to the odd-numbered line sub-pixels by adding the optimum common voltage of the odd-numbered line sub-pixels to the compensation data.

8. The display apparatus of claim 1, wherein the timing controller generates a gate control signal controlling a gate on-time of the odd-numbered line sub-pixels and a gate on-time of the even-numbered line sub-pixels.

9. The display apparatus of claim 8, further comprising:
a gate driver configured to output a gate signal driving the odd-numbered line sub-pixels and a gate on-time of the even-numbered line sub-pixels based on the gate control signal, and
wherein the gate driver outputs the gate signal to the even-numbered line sub-pixels and after a predetermined time the gate driver outputs the gate signal to the odd-numbered line sub-pixels.

10. The display apparatus of claim 1, wherein the display panel comprises:
a switching element disposed on a substrate and comprising a gate electrode, a source electrode and a drain electrode;
an organic layer disposed on the switching element;
a pixel electrode disposed on the organic layer and electrically connected to the drain electrode;
a common electrode overlapping the pixel electrode, and
wherein the source electrode and the drain electrode overlap the gate electrode.

11. A method of driving a display panel, the method comprising:
calculating an optimum common voltage of odd-numbered line sub-pixels and an optimum common voltage of even-numbered line sub-pixels;
generating a data signal and compensation data based on the calculated optimum common voltage of the odd-numbered line sub-pixels and the optimum common voltage of the even-numbered line sub-pixels; and
converting the generated data signal into a data voltage of the odd-numbered line sub-pixels and a data voltage of the even-numbered line sub-pixels and outputting the data voltage to the display panel.

12. The method of claim 11, wherein the data signal is adjusted by the compensation data corresponding to the optimum common voltage of the even-numbered line sub-pixels to the voltage level of a data voltage corresponding to the optimum common voltage of the odd-numbered line sub-pixels.

13. The method of claim 12, wherein
the compensation data is obtained by subtracting the optimum common voltage of the even-numbered line sub-pixels from the optimum common voltage of the odd-numbered line sub-pixels.

14. The method of claim 13, wherein the data driver outputs a data voltage of the even-numbered line sub-pixels by adding the optimum common voltage of the even-numbered line sub-pixels to the compensation data.

15. The method of claim 11, wherein the data signal is adjusted by the compensation data corresponding to the optimum common voltage of the odd-numbered line sub-pixels to the voltage level of a data voltage corresponding to the optimum common voltage of the even-numbered line sub-pixels.

16. The method of claim 11, wherein the compensation data is obtained by subtracting the optimum common voltage of the odd-numbered line sub-pixels from the optimum common voltage of the even-numbered line sub-pixels.

17. The method of claim 16, wherein the data driver outputs a data voltage of the odd-numbered line sub-pixels by adding the optimum common voltage of the odd-numbered line sub-pixels to the compensation data.

18. The method of claim 11, further comprising:
generating a gate control signal controlling a gate on-time of the odd-numbered line sub-pixels and a gate on-time of the even-numbered line sub-pixels.

19. The method of claim 18, further comprising:
outputting a gate signal driving the odd-numbered line sub-pixels and outputting a gate on-time of the even-numbered line sub-pixels based on the gate control signal, and
wherein outputting the gate signal comprises:
outputting the gate signal to the even-numbered line sub-pixels; and
outputting the gate signal to the odd-numbered line sub-pixels at a predetermined time after the gate signal to the even-numbered line sub-pixels is output.

20. The method of claim 11, wherein the display panel comprises:
a switching element disposed on a substrate and comprising a gate electrode, a source electrode and a drain electrode;
an organic layer disposed on the switching element;
a pixel electrode disposed on the organic layer and electrically connected to the drain electrode; and
a common electrode overlapping the pixel electrode,
wherein the source electrode and the drain electrode may overlap the gate electrode.
